(19) United States
(12) Patent Application Publication
(10) Pub. No.: US 2026/0202993 A1
(43) Pub. Date: Jul. 16, 2026

(54) COMPUTING METHOD BASED ON STORAGE DEVICE, MEMORY STORAGE DEVICE AND MEMORY CONTROL CIRCUIT UNIT

(71) Applicant: Hefei Core Storage Electronic Limited, Anhui (CN)

(72) Inventors: Chih-Ling Wang, Anhui (CN); Tong-Jin Liu, Anhui (CN); Qi-Ao Zhu, Anhui (CN); Jing Zhang, Anhui (CN)

(73) Assignee: Hefei Core Storage Electronic Limited, Anhui (CN)

(21) Appl. No.: 19/060,806

(22) Filed: Feb. 24, 2025

(30) Foreign Application Priority Data
Jan. 13, 2025 (CN) 202510045457.2

(51) Int. Cl. G06F 3/06

(52) U.S. Cl. CPC G06F 3/0659; G06F 3/061; G06F 3/0679

(57) ABSTRACT

The present invention provides a computing method based on storage device, a memory storage device and a memory control circuit unit. The method includes: receiving an operation command from a host system, wherein the operation command includes header data, and the header data carries setting information related to a target logical computing; obtaining the header data from the operation command; and instructing a computing circuit in the memory storage device to execute the target logical computing according to the header data. Therefore, the cooperation efficiency between the host system and the memory storage device may be improved.

### CROSS-REFERENCE TO RELATED APPLICATION

This application claims the priority benefit of China application serial no. 202510045457.2, filed on Jan. 13, 2025. The entirety of the above-mentioned patent application is hereby incorporated by reference herein and made a part of this specification.

### BACKGROUND

### Technical Field

The present invention relates a memory control technology, especially to a computing method based on storage device, a memory storage device and a memory control circuit unit.

### Description of Related Art

Portable electronic devices such as mobile phones and notebook computers have grown rapidly in recent years, resulting in a rapid increase in consumer demand for storage media. Since the rewritable non-volatile memory module (e.g., flash memory) has the characteristics of data non-volatility, power saving, small size, and no mechanical structure, it is very suitable for being built into the various portable electronic devices mentioned above.

On the other hand, with the development of computer technology, more and more data processing involves various logical computing (e.g., matrix computing), such as image convolution, mod, binarization and/or data compression. Generally speaking, the above computing is handled by the Graphic Processing Unit (GPU) or dedicated chips in the host system, while the storage device is simply responsible for data storage. However, as the amount of data required for logical computing becomes increasingly large, how to effectively use the host system and memory storage devices to jointly complete computing tasks has become one of the topics that technical personnel in this field are committed to studying.

### SUMMARY

The present invention provides a computing method based on storage device, a memory storage device and a memory control circuit unit, which can improve the cooperation efficiency between a host system and a memory storage device.

An exemplary embodiment of the present invention provides a computing method based on storage device, configured for a memory storage device, wherein the computing method includes: receiving an operation command from a host system, wherein the operation command includes header data, and the header data carries setting information related to a target logical computing; obtaining the header data from the operation command; and instructing a computing circuit in the memory storage device to execute the target logical computing according to the header data.

In exemplary embodiment of the present invention, the setting information includes at least one of activation information related to the target logical computing, type information related to the target logical computing, parameter setting information related to the target logical computing, and logical address information related to the target logical computing, the activation information is configured to indicate an activation of the target logical computing, the type information is configured to indicate a type of the target logical computing, the parameter setting information is configured to indicate at least one parameter used by the target logical computing, and the logical address information is configured to indicate a logical address corresponding to at least part of data participating in the target logical computing.

In exemplary embodiment of the present invention, the operation command further includes first target data, and the step of instructing the computing circuit in the memory storage device to execute the target logical computing according to the header data includes: instructing the computing circuit to perform the target logical computing on the first target data according to the header data.

In exemplary embodiment of the present invention, the step of instructing the computing circuit to perform the target logical computing on the first target data according to the header data includes: reading second target data from a rewritable non-volatile memory module in the memory storage device according to the header data; and instructing the computing circuit to perform the target logical computing on the first target data and the second target data.

In exemplary embodiment of the present invention, the step of instructing the computing circuit in the memory storage device to execute the target logical computing according to the header data includes: reading third target data from a rewritable non-volatile memory module in the memory storage device according to the header data; and instructing the computing circuit to perform the target logical computing on the third target data.

In exemplary embodiment of the present invention, the computing method further includes: in response to the operation command including a write command, storing a computing result of the target logical computing into a rewritable non-volatile memory module in the memory storage device; and in response to the operation command including a read command, returning the computing result to the host system.

An exemplary embodiment of the present invention further provides a memory storage device which includes a connection interface unit, a rewritable non-volatile memory module, a computing circuit and a memory control circuit unit. The connection interface unit is configured to be coupled to a host system. The memory control circuit unit is coupled to the connection interface unit, the rewritable non-volatile memory module and the computing circuit, wherein the memory control circuit unit is configured to: receive an operation command from the host system, wherein the operation command includes header data, and the header data carries setting information related to a target logical computing; obtain the header data from the operation command; and instruct the computing circuit in the memory storage device to execute the target logical computing according to the header data.

In exemplary embodiment of the present invention, the operation command further includes first target data, and the operation of instructing the computing circuit in the memory storage device to execute the target logical computing according to the header data includes: instructing the computing circuit to perform the target logical computing on the first target data according to the header data.

In exemplary embodiment of the present invention, the operation of instructing the computing circuit to perform the target logical computing on the first target data according to the header data includes: reading second target data from the rewritable non-volatile memory module in the memory storage device according to the header data; and instructing the computing circuit to perform the target logical computing on the first target data and the second target data.

In exemplary embodiment of the present invention, the operation of instructing the computing circuit in the memory storage device to execute the target logical computing according to the header data includes: reading third target data from the rewritable non-volatile memory module in the memory storage device according to the header data; and instructing the computing circuit to perform the target logical computing on the third target data.

In exemplary embodiment of the present invention, the memory control circuit unit is further configured to: in response to the operation command including a write command, store a computing result of the target logical computing into the rewritable non-volatile memory module in the memory storage device; and in response to the operation command including a read command, return the computing result to the host system.

An exemplary embodiment of the present invention further provides a memory control circuit unit, configured for controlling a memory storage device, wherein the memory storage device includes a rewritable non-volatile memory module, and the memory control circuit unit includes a host interface, a memory interface and a memory management circuit. The host interface is configured to be coupled to a host system. The memory interface is configured to be coupled to the rewritable non-volatile memory module. The memory management circuit is coupled to the host interface and the memory interface, wherein the memory management circuit is configured to: receive an operation command from the host system, wherein the operation command includes header data, and the header data carries setting information related to a target logical computing; obtain the header data from the operation command; and instruct a computing circuit in the memory storage device to execute the target logical computing according to the header data.

In exemplary embodiment of the present invention, the memory management circuit is further configured to: in response to the operation command including a write command, store a computing result of the target logical computing into the rewritable non-volatile memory module in the memory storage device; and in response to the operation command including a read command, return the computing result to the host system.

Based on the above, after configuring the computing circuit supporting the target logical computing in the memory storage device, the host system can send an operation command including specially designed header data to the memory storage device to instruct the memory storage device to execute the target logical computing. Therefore, the cooperation efficiency between the host system and the memory storage device can be improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a host system, a memory storage device, and an input/output (I/O) device according to an exemplary embodiment of the present invention;

FIG. 2 is a schematic diagram of a host system, a memory storage device and an I/O device according to an exemplary embodiment of the present invention;

FIG. 3 is a schematic diagram of a host system and a memory storage device according to an exemplary embodiment of the present invention;

FIG. 4 is a schematic diagram of a memory storage device according to an exemplary embodiment of the present invention;

FIG. 5 is a schematic diagram of a memory control circuit unit according to an exemplary embodiment of the present invention;

FIG. 6 is a schematic diagram of managing a rewritable non-volatile memory module according to an exemplary embodiment of the present invention;

FIG. 7 is a schematic diagram of an operation command according to an exemplary embodiment of the present invention;

FIG. 8 is a schematic diagram of a memory storage device assisting a host system in executing a target logical computing according to an exemplary embodiment of the present invention;

FIG. 9 is a schematic diagram of a memory storage device assisting a host system in executing a target logical computing according to an exemplary embodiment of the present invention;

FIG. 10 is a flowchart of a computing method based on storage device according to an exemplary embodiment of the present invention.

### DESCRIPTION OF THE EMBODIMENTS

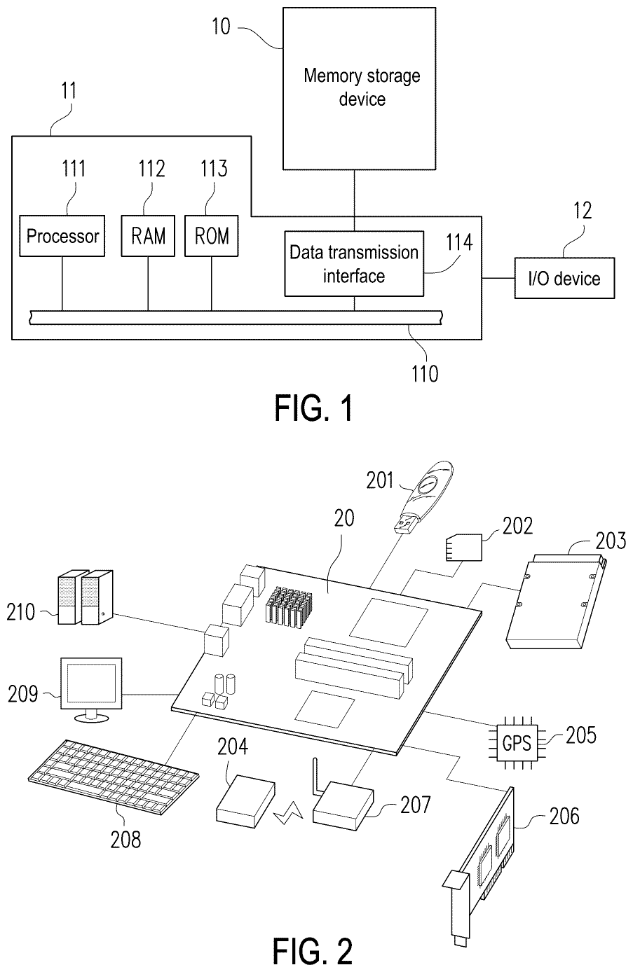

FIG. 1 is a schematic diagram of a host system, a memory storage device, and an input/output (I/O) device according to an exemplary embodiment of the present invention. FIG. 2 is a schematic diagram of a host system, a memory storage device, and an I/O device according to an exemplary embodiment of the present invention.

Referring to FIG. 1 and FIG. 2, the host system 11 may include a processor 111, a random access memory (RAM) 112, a read only memory (ROM) 113, and a data transmission interface 114. The processor 111, the random access memory 112, the read-only memory 113, and the data transmission interface 114 may be connected to a system bus 110.

The host system 11 may be connected to the memory storage device 10 via the data transmission interface 114. For example, the host system 11 may store data to the memory storage device 10 or read data from the memory storage device 10 via the data transmission interface 114. In addition, the host system 11 may be connected to the I/O device 12 via the system bus 110. For example, the host system 11 may transmit output signals to the I/O device 12 or receive input signals from the I/O device 12 via the system bus 110.

In an exemplary embodiment, the processor 111, the random access memory 112, the read-only memory 113 and the data transmission interface 114 may be disposed on a mainboard 20 of the host system 11. The number of the data transmission interface 114 can be one or more. Through the data transmission interface 114, the motherboard 20 can be connected to the memory storage device 10 via a wired or wireless manner.

In an exemplary embodiment, the memory storage device 10 may be, for example, a USB flash drive 201, a memory card 202, a solid state drive (SSD) 203, or a wireless memory storage device 204. The wireless memory storage device 204 may be, for example, a Near Field Communication (NFC) memory storage device, a WiFi memory storage device, a Bluetooth memory storage device, or a low-power Bluetooth memory storage device (e.g., iBeacon), or other memory storage devices based on various wireless communication technologies. In addition, the motherboard 20 can also be connected to various I/O devices such as a global positioning system (GPS) module 205, a network interface card 206, a wireless transmission device 207, a keyboard 208, a screen 209, and a speaker 210 through the system bus 110. For example, in an exemplary embodiment, the motherboard 20 can access the wireless memory storage device 204 via the wireless transmission device 207.

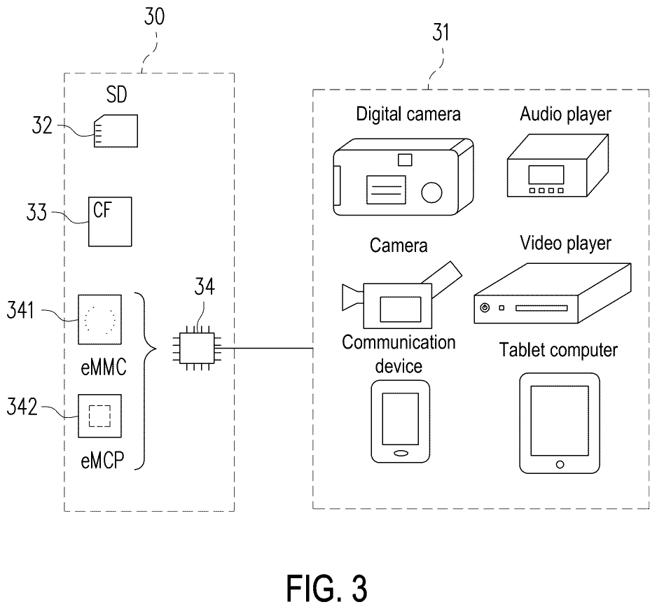

In an exemplary embodiment, the host system 11 is a computer system. In an exemplary embodiment, the host system 11 may be substantially any system that can cooperate with a memory storage device to store data. In an exemplary embodiment, the memory storage device 10 and the host system 11 may include the memory storage device 30 and the host system 31 of FIG. 3, respectively.

FIG. 3 is a schematic diagram of a host system and a memory storage device according to an exemplary embodiment of the present invention. Referring to FIG. 3, a memory storage device 30 can be used in conjunction with a host system 31 to store data. For example, the host system 31 may be a digital camera, a video camera, a communication device, an audio player, a video player, or a tablet computer. For example, the memory storage device 30 may be various non-volatile memory storage devices such as a Secure Digital (SD) card 32, a Compact Flash (CF) card 33, or an embedded storage device 34 used by the host system 31. The embedded storage device 34 includes various types of embedded storage devices such as an embedded Multi Media Card (eMMC) 341 and/or an embedded Multi Chip Package (eMCP) storage device 342 that directly connect a memory module to a substrate of a host system.

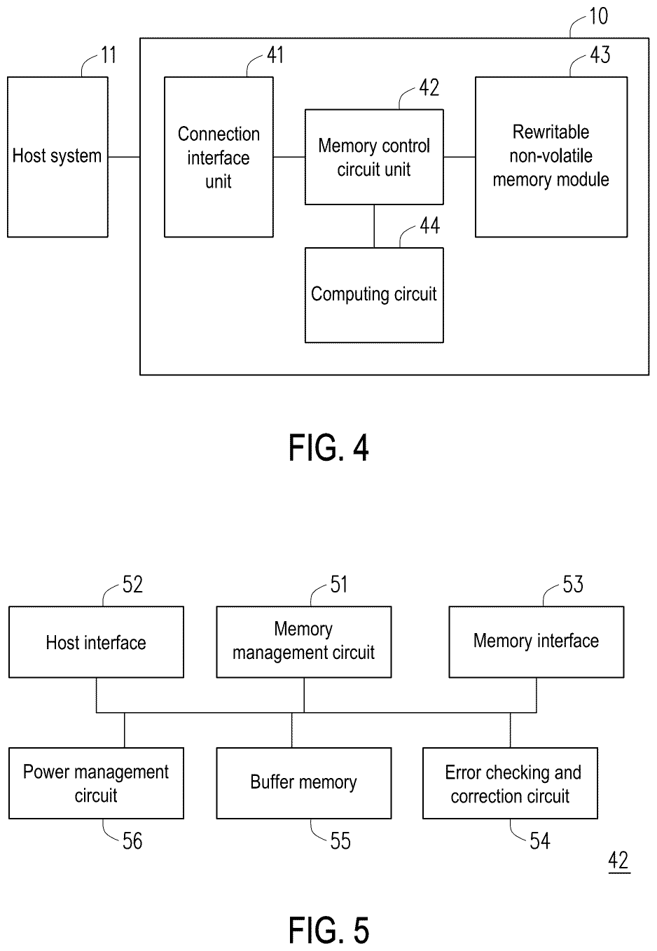

FIG. 4 is a schematic diagram of a memory storage device according to an exemplary embodiment of the present invention. Referring to FIG. 4, the memory storage device 10 includes a connection interface unit 41, a memory control circuit unit 42, a rewritable non-volatile memory module 43, and a computing circuit 44.

The connection interface unit 41 is configured to be coupled to (or to connect to) the host system 11. The memory storage device 10 can communicate with the host system 11 via the connection interface unit 41. For example, the connection interface unit 41 may be compatible with the Peripheral Component Interconnect Express (PCI Express) standard. However, it should be understood that the present invention is not limited thereto, and the connection interface unit 41 may also comply with the Serial Advanced Technology Attachment (SATA) standard, the Parallel Advanced Technology Attachment (PATA) standard, the Institute of Electrical and Electronic Engineers (IEEE) 1394 standard, the Universal Serial Bus (USB) standard, the SD interface standard, the Ultra High Speed-I (UHS-I) interface standard, the Ultra High Speed-II (UHS-II) interface standard, the Memory Stick (MS) interface standard, the MCP interface standard, the MMC interface standard, the eMMC interface standard, the Universal Flash Storage (UFS) interface standard, the eMCP interface standard, the CF interface standard, the Integrated Device Electronics (IDE) standard or other suitable standards. The connection interface unit 41 may be packaged together with the memory control circuit unit 42 in one chip, or the connection interface unit 41 may be disposed outside a chip including the memory control circuit unit 42.

The memory control circuit unit 42 is coupled to the connection interface unit 41, the rewritable non-volatile memory module 43 and the computing circuit 44. The memory control circuit unit 42 is configured to control the rewritable non-volatile memory module 43. For example, the memory control circuit unit 42 may instruct the rewritable non-volatile memory module 43 to perform operations such as writing, reading, and erasing data according to commands from the host system 11. For example, the memory control circuit unit 42 may include a flash memory controller.

The rewritable non-volatile memory module 43 is configured to store data written by the host system 11. The rewritable non-volatile memory module 43 may include a single-level memory cell (Single Level Cell, SLC) NAND type flash memory module (i.e., a flash memory module that can store 1 bit in one memory cell), a second-level memory cell (Multi Level Cell, MLC) NAND type flash memory module (i.e., a flash memory module that can store 2 bits in one memory cell), a third-level memory cell (Triple Level Cell, TLC) NAND type flash memory module (i.e., a flash memory module that can store 3 bits in one memory cell), a fourth-level memory cell (Quad Level Cell, QLC) NAND type flash memory module (i.e., a flash memory module that can store 4 bits in one memory cell), other flash memory modules or other memory modules having the same or similar characteristics.

The computing circuit 44 is configured to perform at least one logical computing. For example, the computing circuit 44 may be configured to perform logical computing such as image convolution, mod, binarization and/or data compression, and the types of logical computing that computing circuit 44 may perform are not limited thereto. In addition, the computing circuit 44 may include a graphics processing unit (GPU), a vision processing unit (VPU), a neural network processor (NPU), or other types of hardware circuits specifically configured to execute the aforementioned various logical computing.

FIG. 5 is a schematic diagram of a memory control circuit unit according to an exemplary embodiment of the present invention. Referring to FIG. 5, the memory control circuit unit 42 includes a memory management circuit 51, a host interface 52 and a memory interface 53.

The memory management circuit 51 is configured to control the overall operation of the memory control circuit unit 42. For example, the memory management circuit 51 may include a central processing unit (CPU), or other programmable general-purpose or special-purpose microprocessor, a digital signal processor (DSP), a programmable controller, an application specific integrated circuit (ASIC), a programmable logic device (PLD), or other similar devices or a combination of these devices.

The host interface 52 is coupled to the memory management circuit 51. The memory management circuit 51 can communicate with the host system 11 through the host interface 52. For example, the host interface 52 may be compatible with PCI Express standard, SATA standard, PATA standard, IEEE 1394 standard, USB standard, SD standard, UHS-I standard, UHS-II standard, MS standard, MMC standard, eMMC standard, UFS standard, CF standard, IDE standard or other suitable data transmission standards. The memory interface 53 is coupled to the memory management circuit 51. The memory management circuit 51 can access the rewritable non-volatile memory module 43 through the memory interface 53.

In an exemplary embodiment, the memory control circuit unit 42 further includes an error checking and correction circuit 54, a buffer memory 55 and a power management circuit 56.

The error checking and correction circuit 54 is coupled to the memory management circuit 51 and is configured to perform error checking and correction operations to ensure the correctness of data. Specifically, when the memory management circuit 51 receives a write command from the host system 11, the error checking and correction circuit 54 can generate a corresponding error correcting code (ECC) and/or error detecting code (EDC) for the data corresponding to the write command, and the memory management circuit 51 can write the data corresponding to the write command and the corresponding error correcting code and/or error checking code into the rewritable non-volatile memory module 43. Afterwards, when the memory management circuit 51 reads data from the rewritable non-volatile memory module 43, the error correcting code and/or error checking code corresponding to the data can be read at the same time, and the error checking and correction circuit 54 may perform an error checking and correction operation on the read data according to the error correcting code and/or error checking code.

The buffer memory 55 is coupled to the memory management circuit 51 and is configured to temporarily store data. The power management circuit 56 is coupled to the memory management circuit 51 and is configured to control the power of the memory storage device 10.

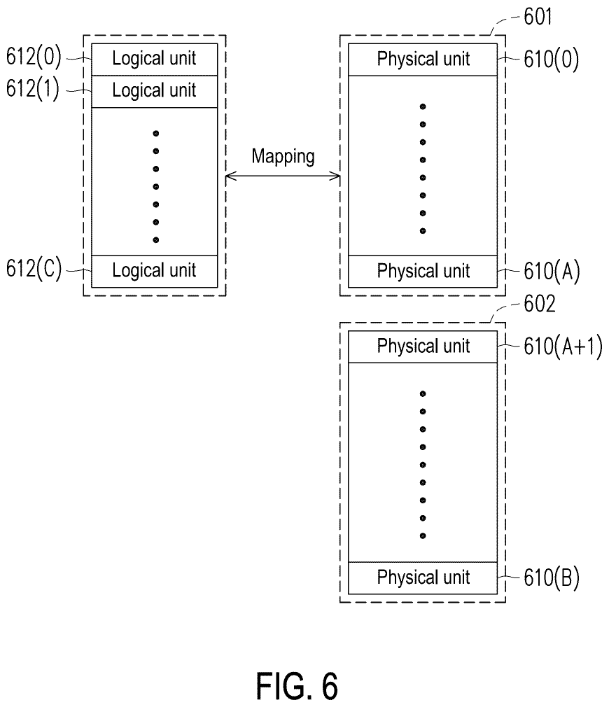

FIG. 6 is a schematic diagram of managing a rewritable non-volatile memory module according to an exemplary embodiment of the present invention. Referring to FIG. 6, the memory management circuit 51 may logically group the physical units 610(0)-610(B) in the rewritable non-volatile memory module 43 into a storage region 601 and a spare region 602.

In an exemplary embodiment, a physical unit refers to a physical address or a physical programming unit. In an exemplary embodiment, a physical unit may also be composed of multiple consecutive or discontinuous physical addresses. In an exemplary embodiment, a physical unit may also refer to a visual block (VB). A visual block can include multiple physical addresses or multiple physical programming units. In an exemplary embodiment, a visual block may include one or more physical erasing units.

In an exemplary embodiment, the physical units 610(0)-610(A) in the storage region 601 are used to store user data (e.g., user data from host system 11 in FIG. 1). For example, the physical units 610(0)-610(A) in the storage region 601 may store valid data and invalid data. The physical units 610(A+1)-610(B) in the spare region 602 do not store data (e.g., the valid data). For example, if a physical unit does not store valid data, this physical unit may be associated (or added) to the spare region 602. In addition, the physical units in the spare region 602 (or the physical units not storing valid data) can be erased. When writing new data, one or more physical units may be selected from the spare region 602 to store the new data. In an exemplary embodiment, the spare region 602 is also called a free pool.

In an exemplary embodiment, the memory management circuit 51 may configure logical units 612(0)-612(C) to map the physical units 610(0)-610(A) in the storage region 601. In an exemplary embodiment, each logical unit corresponds to a logical address. For example, a logical address may include one or more logical block addresses (LBAs) or other logical management unit. In an exemplary embodiment, a logical unit may also correspond to a logical programming unit or be composed of multiple consecutive or discontinuous logical addresses.

In an exemplary embodiment, the memory management circuit 51 may record management data describing the mapping relationship between logical units and physical units (also referred to as logical-to-physical mapping information) in at least one logical-to-physical mapping table. When the host system 11 wants to read data from the memory storage device 10 or write data to the memory storage device 10, the memory management circuit 51 can access the rewritable non-volatile memory module 43 according to the information in the logical to physical mapping table.

In an exemplary embodiment, the host system 11 may send at least one command (also called operation command) to the memory storage device 10. The memory management circuit 51 may receive the operation command from the host system 11. In particular, the operation command may include specially designed header data. This header data can carry setting information related to a specific logical computing (also called target logical computing). For example, the target logical computing may be logical computing, such as convolution, mod, binarization and/or data compression, supported by the computing circuit 44, and the type of the target logical computing is not limited thereto.

After receiving the operation command, the memory management circuit 51 may obtain the header data from the operation command. Then, the memory management circuit 51 can instruct the computing circuit 44 to perform the target logical computing according to the header data. For example, the memory management circuit 51 may configure the computing circuit 44 according to the setting information carried by the header data and then instruct the computing circuit 44 to execute the target logical computing.

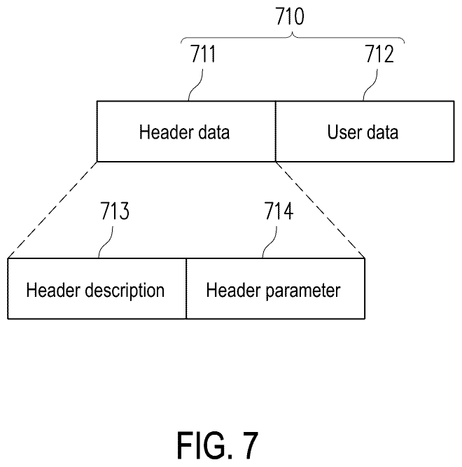

FIG. 7 is a schematic diagram of an operation command according to an exemplary embodiment of the present invention. Referring to FIG. 7, in an exemplary embodiment, the memory management circuit 51 may receive an operation command 710 from the host system 11. The operation command 710 may include header data 711 and user data 712. The header data 711 may carry setting information related to the target logical computing. For example, the header data 711 may include header description data 713 and header parameter data 714. The header description data 713 may carry data length information related to the header parameter data 714. The data length information may reflect a data length of the header parameter data 714. The header parameter data 714 is configured to carry setting information related to the target logical computing. In addition, the user data 712 includes at least part of the data that is intended to participate in the target logical computing (also referred to as first target data).

In an exemplary embodiment, the setting information may include at least one of activation information related to the target logical computing, type information related to the target logical computing, parameter setting information related to the target logical computing, and logical address information related to the target logical computing. The activation information is configured to indicate an activation of the target logical computing. For example, the memory management circuit 51 may activate (e.g., enable) the computing circuit 44 according to the activation information. The type of information is configured to indicate the type of target logical computing. For example, the memory management circuit 51 may set the computing circuit 44 according to the type information to control the computing circuit 44 to execute a specific type of target logical computing. The parameter setting information is configured to indicate at least one parameter used by the target logical computing. For example, the memory management circuit 51 may set, according to the parameter setting information, at least one parameter being used by the computing circuit 44 when the computing circuit 44 executes the target logical computing. The logical address information is configured to indicate the logical address corresponding to at least part of data participating in the target logical computing. For example, the memory management circuit 51 may read at least a portion of data to be involved in the target logical computing from the rewritable non-volatile memory module 43 according to the logical address information. For example, the logical address information may reflect at least one logical address. The memory management circuit 51 can instruct the rewritable non-volatile memory module 43 to read at least part of data (also called second target data or third target data) to participate in the target logical computing from the physical address mapped by the at least one logical address according to the logical address information.

In an exemplary embodiment, the data amount (or data length) of the user data 712 is greater than zero. For example, when the data amount (or data length) of the user data 712 is greater than zero, it can be deemed as the operation command 710 including the user data 712. In an exemplary embodiment, the data amount (or data length) of the user data 712 may be zero. For example, when the data amount (or data length) of the user data 712 is zero, it can be deemed as the operation command 710 not including the user data 712. In addition, the operation command 710 may also include a write command or a read command. The write command is configured to instruct the memory storage device 10 to perform a data write operation. The read command is configured to instruct the memory storage device 10 to perform a data read operation.

In an exemplary embodiment, it is assumed that the operation command 710 includes the user data 712. According to the operation command 710, the memory management circuit 51 may instruct the computing circuit 44 to perform the target logical computing on the first target data carried by the user data 712. For example, after receiving the operation command 710, the memory management circuit 51 may set the computing circuit 44 according to the header data 711. Then, the memory management circuit 51 may input the first target data carried by the user data 712 to the computing circuit 44. The computing circuit 44 may perform the target logical computing according to the first target data.

In an exemplary embodiment, according to the operation command 710, the memory management circuit 51 may also read the second target data from the rewritable non-volatile memory module 43. Then, the memory management circuit 51 may instruct the computing circuit 44 to perform the target logical computing on the first target data and the second target data read from the rewritable non-volatile memory module 43. For example, the memory management circuit 51 may instruct the rewritable non-volatile memory module 43 to read the second target data from a specific physical address according to the logical address information in the header data 711 (or the header parameter data 714). After completing the setting of the computing circuit 44, the memory management circuit 51 may input the first target data carried by the user data 712 and the second target data read from the rewritable non-volatile memory module 43 to the computing circuit 44. The computing circuit 44 may perform the target logical computing according to the first target data and the second target data.

In an exemplary embodiment, it is assumed that the operation command 710 does not include the user data 712. According to the operation command 710, the memory management circuit 51 may read third target data from rewritable non-volatile memory module 43. Then, the memory management circuit 51 may instruct the computing circuit 44 to perform the target logical computing on the third target data. For example, the memory management circuit 51 may instruct the rewritable non-volatile memory module 43 to read the third target data from a specific physical address according to the logical address information in the header data 711 (or the header parameter data 714). After completing the setting of the computing circuit 44, the memory management circuit 51 may input the third target data read from the rewritable non-volatile memory module 43 to the computing circuit 44. The computing circuit 44 may perform the target logical computing according to the third target data.

In an exemplary embodiment, the memory management circuit 51 may determine whether the operation command (e.g., the operation command 710 in FIG. 7) includes a write command or a read command. In response to the operation command including the write command, the memory management circuit 51 can store a computing result of the target logical computing into the rewritable non-volatile memory module 43. Thereafter, the memory management circuit 51 may read the computing result from the rewritable non-volatile memory module 43. Alternatively, in response to the operation command including the read command, the memory management circuit 51 may transmit the computing result back to the host system 11 (i.e., return the computing result to the host system 11).

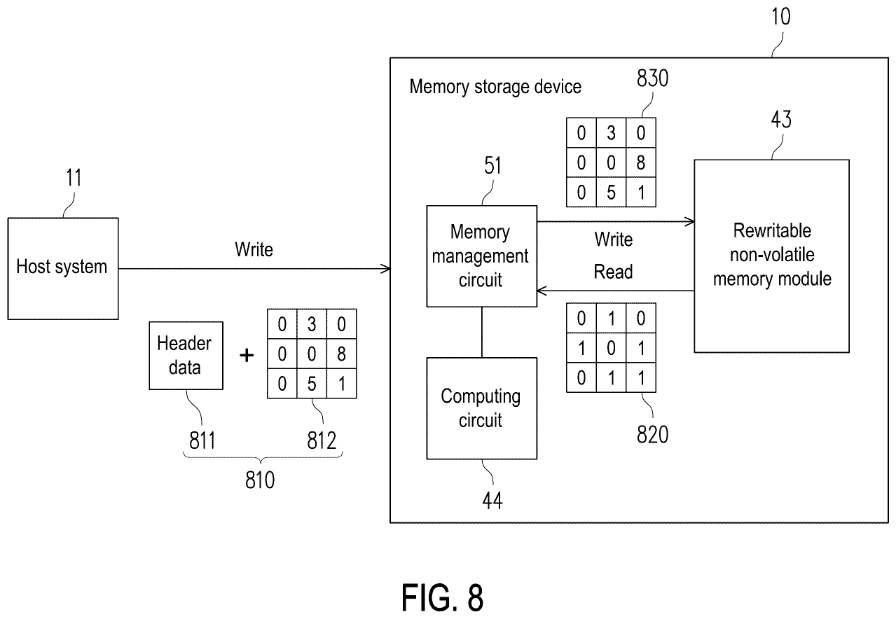

FIG. 8 is a schematic diagram of a memory storage device assisting a host system in executing a target logical computing according to an exemplary embodiment of the present invention. Referring to FIG. 8, in an exemplary embodiment, the memory management circuit 51 may receive an operation command 810 from the host system 11. The operation command 810 includes header data 811 and data 812 (i.e., user data or first target data). In addition, the operation command 810 includes a write command instructing a data write operation.

According to the operation command 810, the memory management circuit 51 can activate the computing circuit 44 and set the computing circuit 44. For example, based on the activation information in the operation command 810, the memory management circuit 51 can activate the computing circuit 44. Based on the type information in the operation command 810, the memory management circuit 51 may set the computing circuit 44 to perform a matrix mod computing (i.e., the target logical computing). In addition, according to the logical address information in the operation command 810, the memory management circuit 51 can read data 820 (i.e., the second target data) from the rewritable non-volatile memory module 43. Then, the memory management circuit 51 may input the data 812 and 820 to the computing circuit 44. The computing circuit 44 can perform matrix mod computing (i.e., the target logical computing) on the data 812 and 820 and then generate data 830. The data 830 may reflect a computing results of the target logical computing. After generating the data 830, in response to the write command in operation command 810, the memory management circuit 51 may store the data 830 into the rewritable non-volatile memory module 43 for subsequent use.

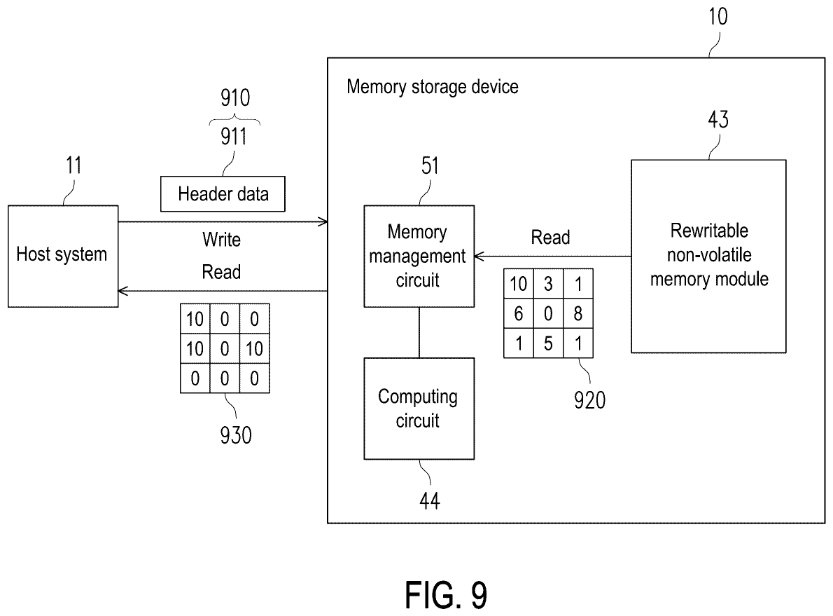

FIG. 9 is a schematic diagram of a memory storage device assisting a host system in executing a target logical computing according to an exemplary embodiment of the present invention. Referring to FIG. 9, in an exemplary embodiment, the memory management circuit 51 may receive an operation command 910 from the host system 11. The operation command 910 includes header data 911. In addition, the operation command 910 includes a write command instructing a data write operation and a read command following the write command.

According to the operation command 910, the memory management circuit 51 can activate the computing circuit 44 and set the computing circuit 44. For example, based on the activation information in the operation command 910, the memory management circuit 51 can activate the computing circuit 44. Based on the type information in the operation command 910, the memory management circuit 51 may set the computing circuit 44 to perform matrix binarization computing (i.e., the target logical computing). According to the parameter setting information in the operation command 910, the memory management circuit 51 can set a maximum value, a minimum value, and a critical value used in the binarization computing to be “10”, “0”, and “5”, respectively. That is, in the binarization computing, if a parameter value is greater than the critical value (i.e., “5”), the parameter value will be adjusted to the maximum value (i.e., “10”); however, if a parameter value is less than the critical value (i.e., “5”), then the parameter value will be adjusted to the minimum value (i.e., “0”). In addition, according to the logical address information in the operation command 910, the memory management circuit 51 can read data 920 (i.e., the third target data) from the rewritable non-volatile memory module 43. Then, the memory management circuit 51 may input the data 920 to the computing circuit 44. The computing circuit 44 can perform the binarization computing (i.e., target logical computing) on the data 920 and then generate data 930. The data 930 may reflect a computing result of the target logical computing.

After generating the data 930, in response to the read command in the operation command 910, the memory management circuit 51 may transmit the data 930 back to the host system 11. It is noted that, in the aforementioned exemplary embodiments, the header data in the operation command may also include other useful information, depending on practical requirements, and the present invention is not limited thereto.

In an exemplary embodiment, the aforementioned operation mode which adds an additional computing operation performed by the memory storage device 10 during the data reading and/or writing process is also called a Compute-Intensive Read/Write (CIRW) mode. This mode is usually used in scenarios where complex computing tasks need to be performed in computer systems and/or storage systems, such as data analysis, machine learning, image processing, etc. This mode has the following beneficial effects: during the data reading or writing process, not only the data is transmitted, but also complex calculation processing is performed; integrate data processing into the storage system to reduce data transmission overhead; ability to perform real-time processing while data is being read or written, improving processing efficiency; by performing computation in the storage system, reliance on the central processing unit (CPU) and network bandwidth is reduced. In addition, in the following exemplary embodiment, the operation executed by the host system 11 may be regarded as the operation executed by the processor 111 of FIG. 1.

In an exemplary embodiment, the host system 11 may perform a pre-processing operation on an image (also referred to as a target image) to generate feature data corresponding to the target image. The feature data can reflect image features related to the target image.

In an exemplary embodiment, the host system 11 may send the operation command to the memory storage device 10 according to the feature data. The operation command may instruct the memory storage device 10 to store the feature data into the rewritable non-volatile memory module 43, read the feature data from the rewritable non-volatile memory module 43, and/or perform logical computing (i.e., the target logical computing) on the feature data.

In an exemplary embodiment, the host system 11 may use the image features to train an artificial intelligence model. For example, the artificial intelligence model may include a Convolutional Neural Network (CNN) model, an Autoencoder model, a Feature Pyramid Networks (FPNs) model, a Transformer model, or a Capsule Network model. Convolutional neural network is a deep learning model specially designed to process data with grid structure (such as images).

The Autoencoder model can be used for dimensionality reduction and feature extraction. After training an autoencoder model to encode key features of an image, the decoder part can be discarded and only the encoder is retained as a feature extractor. This is an unsupervised learning method, mainly used in fields such as feature learning, data dimension reduction and generative models. An autoencoder consists of an input layer, a hidden layer, and an output layer, and its goal is to learn the intrinsic representation of the data by reconstructing the input data.

The feature pyramid network model can capture features at different scales and is very useful for tasks such as object detection. By pre-extracting multi-scale features, the training speed of subsequent models can be accelerated. The transformer model was originally designed for natural language processing, but has also performed well on vision tasks. The transformer model can learn global contextual information from key regions of images. Therefore, it has been widely used in computer vision and other fields. The capsule network model attempts to capture the part-whole hierarchy of objects, which is very useful for recognizing objects and their poses in images.

Capsule network is an architecture designed to improve the performance of traditional convolutional neural networks (CNNs) in image recognition tasks, especially in solving problems such as object pose estimation and translation invariance. The main feature of capsule network is that it uses so-called “capsule” units instead of traditional neurons. These capsule units can not only capture the basic features of the object, but also capture the object's posture information (such as direction, size, etc.). Each capsule is actually a vector that can represent multiple attributes of a feature, not just a single scalar activation value. Through dynamic routing algorithms, capsule networks are better able to handle changes in the position and shape of objects in images. It is noted that, the artificial intelligence model may also include other types of models, which is not limited by the present invention.

In an exemplary embodiment, the host system 11 may use a metadata index strategy to store the key features of the target image (i.e., the feature data) and the complete target image. In an exemplary embodiment, the host system 11 may create an index file. This index file can record information such as a storage location and size of each key feature of the target image. Thereafter, the host system 11 may query the index file to obtain each key feature (i.e., the feature data) of the target image.

In an exemplary embodiment, in the pre-processing operation, the host system 11 may divide the target image into multiple parts (e.g., grids) and create a separate file for each part. Afterwards, the files corresponding to each part can be loaded and used independently, thus improving the flexibility of operation.

In an exemplary embodiment, the host system 11 may create corresponding metadata for the target image and each segmented portion. The metadata includes identification information of the target image, location information of each part of the target image (such as grid location), file names or storage locations corresponding to each part of the target image, or category labels, etc., which are helpful for identifying and/or classifying each part segmented from the target image (also called attribute data).

In an exemplary embodiment, the host system 11 may record the metadata in the index file. In addition, the host system 11 may store the target image and the parts divided from the target image in the memory storage device 10.

In an exemplary embodiment, the target image may be stored in the memory storage device 10 based on a certain storage mode (also referred to as a first storage mode), and the parts segmented from the target image may be stored in the memory storage device 10 based on another storage mode (also referred to as a second storage mode). For example, the first storage mode may include the triple-level memory cell (TLC) mode or the quad-level memory cell (QLC) mode, and the second storage mode may include the single-level memory cell (SLC) mode. In addition, the first storage mode and the second storage mode may also be adjusted according to practical requirements, and the present invention is not limited thereto.

In an exemplary embodiment, the host system 11 may query the index file to obtain metadata corresponding to a specific portion segmented from the target image. Then, the host system 11 may generate an operation command with specific header data according to the obtained metadata. Thereafter, in the aforementioned Compute-Intensive Read/Write (CIRW), the host system 11 may access the memory storage device 10 through the operation command. In particular, during accessing the memory storage device 10 through the operation command, the host system 11 may instruct the memory storage device 10 to perform the target logical computing on a specific portion segmented from the target image through the header data carried by the operation command. For details of the related operations, please refer to the descriptions of the aforementioned exemplary embodiments (e.g., FIG. 8 and FIG. 9), which will not be repeated here.

In an exemplary embodiment, the artificial intelligence model does not need to access the complete image data for training, but can be trained by extracting key information of the image (i.e., a specific part segmented from the target image), thereby improving training efficiency. In other words, by pre-processing (e.g., segmenting) the image data at a storage stage, the time consumption required to load the entire image during training can be reduced. This approach not only simplifies the data preparation process for model training, but also significantly reduces the demand for computing resources.

In an exemplary embodiment, in the metadata index strategy, the host system 11 may select a suitable database to store metadata according to the data access mode and the data volume. For example, the host system 11 may select a suitable database from a relational database, a NoSQL database, or other types of databases according to the content of the metadata to be stored, the complexity of the created index, and/or the type of artificial intelligence model used in combination, and then use the selected database to store the metadata. In particular, reasonable metadata storage and access design can greatly improve the efficiency of model training and make the storage system more flexible and powerful.

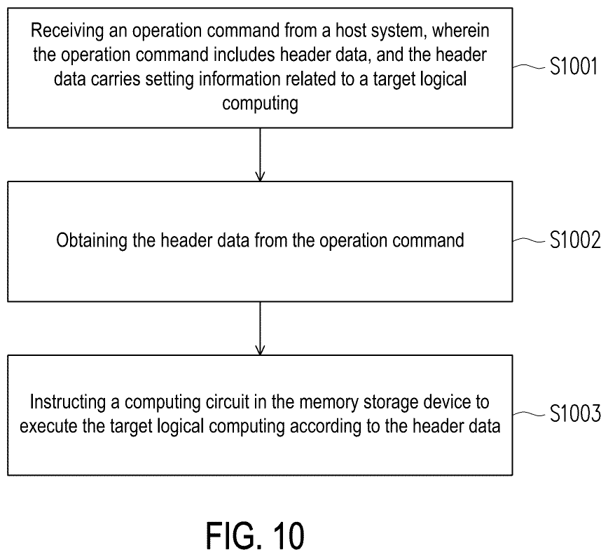

FIG. 10 is a flowchart of a computing method based on storage device according to an exemplary embodiment of the present invention. Referring to FIG. 10, in step S1001, an operation command is received from a host system, wherein the operation command includes header data, and the header data carries setting information related to a target logical computing. In step S1002, the header data is obtained from the operation command. In step S1003, according to the header data, the computing circuit in the memory storage device is instructed to execute the target logical computing.

However, each step in FIG. 10 has been described in detail above and will not be repeated here. It should be noted that each step in FIG. 10 can be implemented as multiple program codes or circuits, and the present invention is not limited thereto. In addition, the method of FIG. 10 can be used in conjunction with the above exemplary embodiment, or can be used alone, and the present invention is not limited thereto.

In summary, the computing method based on storage device, memory storage device and memory control circuit unit proposed in the present invention involves a configuration of computing circuit supporting a target logical computing in the memory storage device. Afterwards, the host system can send an operation command containing specially designed header data to the memory storage device to instruct the memory storage device to perform this target logical computing. Therefore, the cooperation efficiency between the host system and the memory storage device can be improved.

On the other hand, the computing method based on storage device, the memory storage device and the memory control circuit unit proposed in the present invention can synchronously complete the logical computing of data when the host system writes data to or reads data from the storage device. Therefore, the computing method, the memory storage device and the memory control circuit unit proposed in the invention can provide at least one of the following advantages:
1. Reduce the hardware specifications and/or construction costs of the host system (e.g., computer terminal system). For example, the host system may not need to install additional and/or specialized chips.
2. The storage device shares the computing task. Whether using a dedicated chip or a central processing unit (CPU) for matrix calculations, there is always some data that needs to be read from the storage device and then calculated. However, after using the present invention, what is read out is the result after calculation, which reduces the calculation tasks of other calculation units.
3. Improve the overall efficiency of the system. Traditionally, the host system often calculates data and then stores the result, or reads data and uses the result after calculation. There are two places in this process where time is wasted: one is waiting for data to be read or written, and the other is processing and calculating the data in the memory. While waiting for data, the process can be suspended and the CPU can handle other tasks, but the calculation of data still occupies the CPU. However, after using the present invention, the time for data calculation can be hidden in the time for waiting for data transmission.
4. Reduce system complexity. For some small systems, such as driving recorders and recording equipment, there are some requirements for data compression and simple calculations. By using the present invention, the integration of these small systems can be further improved, thereby simplifying the system, reducing costs and improving stability.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A computing method based on storage device, configured for a memory storage device, wherein the computing method comprises:
receiving an operation command from a host system, wherein the operation command comprises header data, and the header data carries setting information related to a target logical computing;
obtaining the header data from the operation command; and
instructing a computing circuit in the memory storage device to execute the target logical computing according to the header data.

2. The computing method according to claim 1, wherein the setting information comprises at least one of activation information related to the target logical computing, type information related to the target logical computing, parameter setting information related to the target logical computing, and logical address information related to the target logical computing,
the activation information is configured to indicate an activation of the target logical computing,
the type information is configured to indicate a type of the target logical computing,
the parameter setting information is configured to indicate at least one parameter used by the target logical computing, and
the logical address information is configured to indicate a logical address corresponding to at least part of data participating in the target logical computing.

3. The computing method according to claim 1, wherein the operation command further comprises first target data, and the step of instructing the computing circuit in the memory storage device to execute the target logical computing according to the header data comprises:
instructing the computing circuit to perform the target logical computing on the first target data according to the header data.

4. The computing method according to claim 3, wherein the step of instructing the computing circuit to perform the target logical computing on the first target data according to the header data comprises:
reading second target data from a rewritable non-volatile memory module in the memory storage device according to the header data; and
instructing the computing circuit to perform the target logical computing on the first target data and the second target data.

5. The computing method according to claim 1, wherein the step of instructing the computing circuit in the memory storage device to execute the target logical computing according to the header data comprises:
reading third target data from a rewritable non-volatile memory module in the memory storage device according to the header data; and
instructing the computing circuit to perform the target logical computing on the third target data.

6. The computing method according to claim 1, further comprising:
in response to the operation command comprising a write command, storing a computing result of the target logical computing into a rewritable non-volatile memory module in the memory storage device; and
in response to the operation command comprising a read command, returning the computing result to the host system.

7. A memory storage device, comprising:
a connection interface unit, configured to be coupled to a host system;
a rewritable non-volatile memory module;
a computing circuit; and
a memory control circuit unit coupled to the connection interface unit, the rewritable non-volatile memory module and the computing circuit,
wherein the memory control circuit unit is configured to:
receive an operation command from the host system, wherein the operation command comprises header data, and the header data carries setting information related to a target logical computing;
obtain the header data from the operation command; and
instruct the computing circuit in the memory storage device to execute the target logical computing according to the header data.

8. The memory storage device according to claim 7, wherein the setting information comprises at least one of activation information related to the target logical computing, type information related to the target logical computing, parameter setting information related to the target logical computing, and logical address information related to the target logical computing,
the activation information is configured to indicate an activation of the target logical computing,
the type information is configured to indicate a type of the target logical computing,
the parameter setting information is configured to indicate at least one parameter used by the target logical computing, and
the logical address information is configured to indicate a logical address corresponding to at least part of data participating in the target logical computing.

9. The memory storage device according to claim 7, wherein the operation command further comprises first target data, and the operation of instructing the computing circuit in the memory storage device to execute the target logical computing according to the header data comprises:
instructing the computing circuit to perform the target logical computing on the first target data according to the header data.

10. The memory storage device according to claim 9, wherein the operation of instructing the computing circuit to perform the target logical computing on the first target data according to the header data comprises:
reading second target data from the rewritable non-volatile memory module in the memory storage device according to the header data; and
instructing the computing circuit to perform the target logical computing on the first target data and the second target data.

11. The memory storage device according to claim 7, wherein the operation of instructing the computing circuit in the memory storage device to execute the target logical computing according to the header data comprises:
reading third target data from the rewritable non-volatile memory module in the memory storage device according to the header data; and
instructing the computing circuit to perform the target logical computing on the third target data.

12. The memory storage device according to claim 7, wherein the memory control circuit unit is further configured to:
in response to the operation command comprising a write command, store a computing result of the target logical computing into the rewritable non-volatile memory module in the memory storage device; and
in response to the operation command comprising a read command, return the computing result to the host system.

13. A memory control circuit unit, configured for controlling a memory storage device, wherein the memory storage device comprises a rewritable non-volatile memory module, and the memory control circuit unit comprises:
a host interface, configured to be coupled to a host system;
a memory interface, configured to be coupled to the rewritable non-volatile memory module; and
a memory management circuit, coupled to the host interface and the memory interface,
wherein the memory management circuit is configured to:
receive an operation command from the host system, wherein the operation command comprises header data, and the header data carries setting information related to a target logical computing;
obtain the header data from the operation command; and
instruct a computing circuit in the memory storage device to execute the target logical computing according to the header data.

14. The memory control circuit unit according to claim 13, wherein the setting information comprises at least one of activation information related to the target logical computing, type information related to the target logical computing, parameter setting information related to the target logical computing, and logical address information related to the target logical computing,
the activation information is configured to indicate an activation of the target logical computing,
the type information is configured to indicate a type of the target logical computing,
the parameter setting information is configured to indicate at least one parameter used by the target logical computing, and
the logical address information is configured to indicate a logical address corresponding to at least part of data participating in the target logical computing.

15. The memory control circuit unit according to claim 13, wherein the operation command further comprises first target data, and the operation of instructing the computing circuit in the memory storage device to execute the target logical computing according to the header data comprises:
instructing the computing circuit to perform the target logical computing on the first target data according to the header data.

16. The memory control circuit unit according to claim 15, wherein the operation of instructing the computing circuit to perform the target logical computing on the first target data according to the header data comprises:
reading second target data from the rewritable non-volatile memory module in the memory storage device according to the header data; and
instructing the computing circuit to perform the target logical computing on the first target data and the second target data.

17. The memory control circuit unit according to claim 13, wherein the operation of instructing the computing circuit in the memory storage device to execute the target logical computing according to the header data comprises:
reading third target data from the rewritable non-volatile memory module in the memory storage device according to the header data; and
instructing the computing circuit to perform the target logical computing on the third target data.

18. The memory control circuit unit according to claim 13, wherein the memory management circuit is further configured to:
in response to the operation command comprising a write command, store a computing result of the target logical computing into the rewritable non-volatile memory module in the memory storage device; and
in response to the operation command comprising a read command, return the computing result to the host system.
